(19) United States
(12) Patent Application Publication
(10) Pub. No.: US 2022/0112869 A1
(43) Pub. Date: Apr. 14, 2022

(54) Method and Device for Predicting and Avoiding Condensation of Humidity in an Intake System of an Internal Combustion Engine After Engine Switch Off

(71) Applicant: Hitachi Astemo, Ltd., Hitachinaka-shi, Ibaraki (JP)

(72) Inventors: Andrea MARCHI, Schwaig-Oberding (DE); Masayuki SARUWATARI, Hitachinaka-shi, Ibaraki (JP); Yoshihito YASUKAWA, Schwaig-Oberding (DE)

(21) Appl. No.: 17/424,369

(22) PCT Filed: Feb. 4, 2020
(86) PCT No.: PCT/JP2020/004025

§ 371 Date: Jul. 20, 2021

(30) Foreign Application Priority Data
Feb. 19, 2019 (DE) 10 2019 202 213.8

(51) Int. Cl. F02M 35/10; F02B 29/00; F02D 13/02; F02B 39/10

(52) U.S. Cl. CPC F02M 35/1038; F02B 29/00; F02D 2200/70; F02B 39/10; F02D 13/0242

(57) ABSTRACT

The present invention relates to a method and a control unit for avoiding condensation of humidity in an intake system of an internal combustion engine after engine switch off. Condensed liquid in the intake system of the stopped engine can lead to icing, corrosion and a hydrostatic lock at the next engine start. To prevent such an engine damage, it is necessary to determine if and in which amount condensed liquid occurs in the cooled intake system and to initiate appropriate actions to eliminate the liquid therefrom. The present invention predicts the occurrence of condensation in the intake system of the cooled engine and initiates corrective measures at engine switch off and during the cooling down period.

### TECHNICAL FIELD

The present invention relates to a method and a control unit for predicting and avoiding condensation of humidity in an intake system of an internal combustion engine after engine switch off.

### BACKGROUND ART

In order to improve the efficiency of internal combustion engines and to decrease engine emissions, different technologies are under investigation. Especially exhaust gas recirculation (EGR) and water injection are known as effective measures to lower the combustion temperature and thus to enhance efficiency and reduce emissions.

Nevertheless, both measures increase the risk that condensation of humidity occurs in the intake system of the engine, especially during the cool down period of the stopped engine. In case of EGR, the recirculated exhaust gas contains a high amount of humidity which may condense by cooling when entering the intake system. Water injection, however, is mostly applied as port injection, wherein the water is injected into the intake ports instead of injecting it directly into the cylinder. Therefore, a portion of the injected water does not reach the cylinder but accumulates as wall film on the intake port walls from which it may vaporize and enter into the intake system after the engine is switched off.

Condensed liquid in the intake system of the stopped engine can lead to icing, corrosion and a hydrostatic lock at the next engine start. To prevent such an engine damage, it is necessary to determine if and in which amount condensed liquid occurs in the cooled intake system and to initiate appropriate actions to eliminate the liquid therefrom.

### CITATION LIST

### Patent Literature

PTL 1: Patent Literature 1: JP 2017-206984 A

### SUMMARY OF INVENTION

### Technical Problem

Patent Literature 1 describes a method and a control device for predicting water condensation in the suction passage of a supercharged engine having EGR. However, the prediction of water condensation is only disclosed for the running engine without considering condensation which may occur after engine stop.

An object of the invention is to realize a method and a control unit for avoiding condensation in an intake system of an internal combustion engine being capable of reliably prevent engine damage.

### Solution to Problem

The above-described object is solved by the subject-matter according to the independent claims. Further preferred developments are described by the dependent claims.

Preferably, the method for avoiding condensation of humidity in an intake system of an internal combustion engine (or shortly “engine”), may determine a liquid mass condensing in the intake system at a predetermined time after engine switch off, based on a determined humidity in the intake system, a determined temperature in the intake system and a determined ambient temperature; and/or may initiate a corrective measure if the determined condensed liquid mass exceeds a predetermined threshold. In this context, the term “determine” may preferably include the meanings of “measure”, “calculate” and “estimate”. The predetermined time after engine switch off request, as for which the condensed liquid mass may be determined, may be the end of the engine cool down period when the temperature in the intake system has reached the ambient temperature. Additionally, potential condensate may be determined at one or more timings during the engine cool down period. This allows for carrying out early measures in order to avoid that the amount of condensate in the intake system exceeds a level which could lead to engine damage. The method may predict the condensed liquid mass immediately after engine switch off request. This means that the amount of potential condensate may be estimated when the control unit receives the request to stop the engine so that measures can be initiated before the engine is fully stopped. The engine switch off request may be initiated by the driver or by a control function of the control unit such as a start-stop function.

According to an aspect, the prediction of the condensed liquid mass may comprise the steps of:

measuring the relative humidity and the temperature in the intake system and calculating a first humidity ratio in the intake system based on the measured values,

estimating a liquid mass stored as film on walls of the intake system,

calculating a second humidity ratio in the intake system including the liquid wall film mass and the first humidity ratio,

measuring the ambient temperature and estimating a cooling down period until the intake air cools down to ambient temperature, and/or

calculating the condensed liquid mass depending on the second humidity ratio and an estimated soaking temperature at end of the cooling down period.

The relative humidity expressed as a percentage may indicate a present state of absolute humidity relative to a maximum humidity given the same temperature. A humidity sensor may be mounted at a representative position in the intake system and may measure the relative humidity therein. The humidity ratio may be calculated depending on the measured relative humidity and may be the ratio between the actual mass of water vapor present in moist air to the mass of the dry air (e.g., kg water/kg air). The wall film may be estimated based on the injected water amount in the preceding cycle(s) before engine switch off request and the currently measured temperature, pressure and humidity in the intake system. This wall film may vaporize after engine switch off due to the increased temperature in the intake ports and therefore the resulting humidity ratio in the whole intake system may increase. The cooling down period of the engine may be estimated using Newton's cooling law. For this purpose, the time for cooling down the air in the intake system may firstly be calculated based on the currently measured temperature in the intake system and the currently measured ambient temperature. Subsequently, the predicted ambient temperature at the calculated end of the cooling down period may be estimated, for example, based on whether reports, which can be received via the internet from the next available whether station. If the forecasted ambient temperature strongly differs from the currently measured ambient temperature, some iteration steps may be necessary to predict the end of the engine cool down period and the soaking temperature with sufficient accuracy. The soaking temperature may be achieved when the temperature inside the intake system is identical to the ambient temperature.

Further, if the predicted condensed liquid mass exceeds a first predetermined threshold and the estimated soaking temperature at the end of the cooling down period is higher than a first predetermined temperature, a first corrective measure may be initiated after engine switch off request. To perform the first corrective measure, a predetermined number of cranking cycles after engine switch off request may be initiated. The number of cranking cycles may be in the range of one to five cycles. The cranking may be driven by the flywheel of the engine or may be supported by the electric starter, which may be a 48-volt starter generator. These cranking cycles may ensure a sufficient air exchange inside the intake system to avoid condensation caused by humid air during the cooling down period.

Preferably, if the predicted condensed liquid mass exceeds a second predetermined threshold smaller than the first predetermined threshold, and the estimated soaking temperature at the end of the cooling down period is lower than the first predetermined temperature, a second corrective measure may be initiated after engine switch off request. The first predetermined temperature related to the first and second corrective measure may be set around freezing point, preferably in a temperature range of 0° C. to 5° C., in order to differentiate between a water mass which could cause damages by icing and a water mass which could cause damages by liquid water. Since icing can result in more severe damages the second predetermined threshold should be smaller than the first one. Examples for defining possible liquid mass thresholds are given related to the FIGS. 3 and 4.

To perform the second corrective measure, a predetermined number of scavenging cycles after engine switch off request may be initiated, by switching an intake valve and an exhaust valve in a valve overlap position and controlling the e-booster to provide a predetermined boost pressure. This means that during the cranking cycles as described above, the gas exchange valves are switched to a valve overlap position and the incoming air is pushed through the engine driven by a boost pressure which is provided by the e-booster in order to additionally support the air exchange inside the intake system. The predetermined number of scavenging cycles may be in a range one to five cycles and the predetermined boost pressure may be in a range of 0.1 to 0.5 bar above the ambient pressure, in order to assure a sufficient scavenging of the intake system.

Furthermore, the humidity in the intake system, the temperature in the intake system and the ambient temperature may frequently be measured at predetermined timings during the cooling down period after engine switch off until the temperature in the intake system is equal to the ambient temperature and the condensed liquid mass is determined based on the measured values at each timing. The predetermined timings may be scheduled every 1 s to 20 min after engine switch off until the soaking temperature is reached. The condensed liquid mass determined at these timings may be calculated based on the currently measured temperature and humidity in the intake system and the conditions in the intake system at engine switch off.

Preferably, if the determined condensed liquid mass exceeds the first predetermined threshold, and the measured ambient temperature is higher than a second predetermined temperature, a third corrective measure may be initiated. The second predetermined temperature should be above the freezing point to avoid icing in the intake system and may preferably be set in a temperature range of 10° C. to 15° C. Since the air exchange after engine switch off has to be performed at the stopped engine, only the e-booster can deliver a mass flow through the engine. Therefore, to perform the third corrective measure, the intake valve and the exhaust valve may be switched in the valve overlap position and/or a venting valve may be opened, and the e-booster may be controlled to deliver a first predetermined air mass flow for a first predetermined ventilation time. The first predetermined mass flow multiplied with the first predetermined ventilation time should be larger than the displacement of the engine multiplied with the air density in the intake port, in order to replace the engine charge by fresh air.

Furthermore, if the determined condensed liquid mass exceeds the second predetermined threshold, and the measured ambient temperature is lower than the second predetermined temperature, a fourth corrective measure is initiated. To perform the fourth corrective measure, the intake valve and the exhaust valve may be switched in the valve overlap position and/or the venting valve may be opened, and the e-booster may be controlled to deliver a second predetermined air mass flow for a second predetermined ventilation time. The second predetermined mass flow multiplied with the first predetermined ventilation time should be, for example, two or three times larger than the displacement of the engine multiplied with the air density in the intake port, to ensure that the engine charge is completely replaced by fresh air.

Further, the invention may include a control unit configured to perform the above described method or aspects thereof and

an internal combustion engine having at least one cylinder, at least one intake valve, at least one exhaust valve, at least one e-booster, at least one venting valve, at least one humidity sensor, at least one temperature sensor, at least one non-combustible fluid injector for injecting non-combustible fluid in at least one intake port of the internal combustion engine and the control unit.

Further, the invention may include a computer program product storable in a memory comprising instructions which, when carried out by a computer or a computing unit, cause the computer to perform the above described method or aspects thereof, as well as a computer-readable [storage] medium comprising instructions which, when executed by a computer, cause the computer to carry out said method or aspects thereof.

### Advantageous Effects of Invention

Summarizing, the invention allows for determining potential condensation inside the intake system of an internal combustion engine after engine switch off and for performing corrective measures to reliably prevent such condensation in order to avoid engine damage caused by icing, corrosion or hydrostatic lock.

In the following the invention and aspects thereof will be further explained based on at least one preferential example with reference to the attached exemplary and schematical drawings.

### BRIEF DESCRIPTION OF DRAWINGS

FIG. 1 depicts a schematical diagram of a turbocharged three-cylinder engine;

FIG. 2 shows schematically a cylinder of an internal combustion engine, wherein the gas exchange valves are switched into a valve overlapping position;

FIG. 3 depicts schematically an exemplary water amount in the intake system which should not be exceeded to avoid that the throttle plate is blocked in case of icing;

FIG. 4 shows schematically an exemplary water amount in the cylinder which should not be exceeded to avoid an engine damage by a hydrostatic lock;

FIG. 5 (5a and 5b) shows diagrams which exemplary illustrate the formation of condensed water after switching off the engine;

FIG. 6 depicts a flow chart which describes an example for predicting and preventing condensed water in the cooled engine at engine switch off;

FIG. 7 depicts a flow chart which describes an example for determining and preventing condensed water during the cooling down period of the engine.

### DESCRIPTION OF EMBODIMENTS

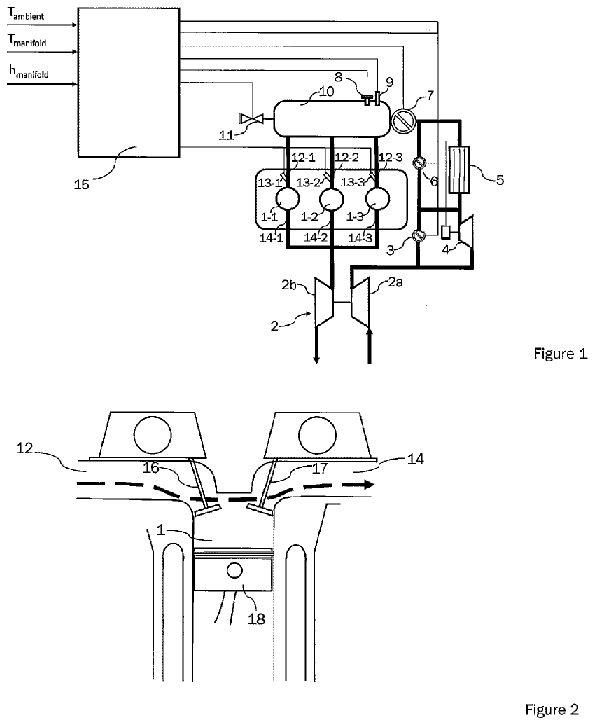

In FIG. 1 a three-cylinder turbocharged engine is schematically illustrated. The number of cylinders is not limited to three but may be any number of cylinders as known. The engine comprises a turbocharger 2, having a compressor 2a and a turbine 2b, an electrical booster (e-booster) 4, a first bypass plate 3 to bypass the e-booster 4, a charge air cooler 5, a second bypass plate 6 to bypass the charge air cooler 5, a throttle plate 7 mounted at an intake manifold 10, which is equipped with a humidity sensor 8, an intake temperature sensor 9 and a venting valve 11. The humidity sensor 8, the temperature sensor 9 and the venting valve 11 may also be mounted at any other representative position in the intake system. Further the engine includes intake ports 12-1 to 12-3, each connecting the intake manifold 10 with a respective cylinder 1-1 to 1-3, in order to draw fresh charge into each cylinder 1-1 to 1-3. In each intake port 12-1 to 12-3 a non-combustible fluid injector 13-1 to 13-3 is disposed, which is connected to the inside of the respective intake port and configured to inject non-combustible fluid into the intake port. The non-combustible fluid may preferably be water. To discharge the exhaust gases, each cylinder 1-1 to 1-3 is connected to an exhaust port 14-1 to 14-3 from which the exhaust gases are led to the turbine 2b of the turbocharger 2 in order to propel the compressor 2a before leaving the exhaust system of the engine.

Further, the engine comprises a at least one control unit 15 which may control the turbocharger 2, the e-booster 4, the bypass plates 3, 6, the throttle plate 7, the venting valve 11, the gas exchange valves (not depicted in FIG. 1) and the water injectors 13-1 to 13-3. Furthermore, the control unit 15 may receive signals from an ambient temperature sensor (not depicted), the intake humidity sensor 8 and the intake temperature sensor 9 to determine/predict the amount of condensed water when the engine is cooled down and during the cooling down period, respectively. The number and type of actuators and sensors is not limited to the depicted example.

The at least one control unit 15 may be integrated into the internal combustion engine or, alternatively, it may be disposed at a position within a vehicle remote to the combustion engine, and the control unit 15 and the engine may be connected via one or more signal lines. The control unit 15 may be the engine control unit (ECU) or a separate control device. There may also be a plurality of control units 15-1 to 15-x which may control subgroups of the controlled actuators, e.g. one control unit 15-1 may control only the water injectors, another control unit 15-2 may control only the charging and so on.

During steady state engine operation, fresh air may be conducted via the compressor 2a, the first bypass plate 3 and the charge air cooler 5 to the throttle plate 7 which may adjust the required amount of air for the combustion in the cylinders 1-1 to 1-3. In order to guide the air through the charge air cooler 5, the second bypass plate 6 has to be closed. At low engine temperature and/or load it may be beneficial to bypass the charge air cooler 5 by opening the second bypass plate 6.

During a transient engine operation mode, which requires a fast increase of engine power, the incoming air may be conducted via the compressor 2a to the e-booster 4 by closing the first bypass plate 3. In this case the throttle plate 7 may be fully opened, and the air may be pushed into the cylinders 1-1 to 1-3 at an increased pressure level to enable the required power output of the engine. To ensure sufficient cooling of the high compressed air, the second bypass plate 6 may also be closed, so that the air may be directed through the charge air cooler 5.

In order to avoid knocking and high exhaust gas temperatures, water injection can be performed during transient operation mode and/or at high engine load and speed. For this purpose, water may be injected by the water injectors 13-1 to 13-3 into the intake ports 12-1 to 12-3 from which it is can enter into the cylinders 1-1 to 1-3 to decrease the combustion temperature therein. Since water injection into the intake ports 12-1 to 12-3 leads to a wall film therein, an amount of injected water may remain in the intake system when the engine is switched off. Therefore, the use of port water injection may increase the risk of an engine damage caused by water occurring in the intake system.

In FIG. 2 a schematic view of an exemplary cylinder 1 of an internal combustion engine is depicted. During an intake stroke of the engine when a piston 18 inside the cylinder 1 moves downward, fresh load can enter into the cylinder 1 from the intake port 12 through an intake valve 16. After a combustion has taken place in a working stroke of the engine, exhaust gases can be discharged by the upward movement of the piston 18 through an exhaust valve 17 into the exhaust port 14 during an exhaust stroke of the engine.

During a cranking cycle of the engine no combustion takes place, so that only air is pumped through the engine. To perform the first corrective measure to avoid condensed water in the intake system of the cooled engine, one or more cranking cycles may be performed during the shut down of the engine. For this purpose, both bypass plates 3, 6 and the throttle plate 7 may be fully opened to allow for an undisturbed inflow of dry fresh air into the engine.

For performing the second corrective measure, the air flow through the engine during the cranking cycles may be supported by the e-booster 4 which may provide a boost pressure in the intake port 12 being above the pressure in the exhaust port 14. In this case the first bypass plate 3 may be closed and the second bypass plate 6 as well as the throttle plate 7 may be fully opened. Additionally, the intake valve 16 and the exhaust valve 17 may be switched into a valve overlap position, so that both valves are open to bypass the cylinder 1 (see doted arrow in FIG. 2) which allows for an effective scavenging of the intake system.

For performing the third and fourth corrective measure at the stopped engine during the engine cool down period, scavenging air can only be delivered by the e-booster 4. Similar to the second corrective measure the first bypass plate 3 may be closed and the second bypass plate 6 as well as the throttle plate 7 may be fully opened. Further, the intake valve 16 and the exhaust valve 17 may be switched into a valve overlap position, so that both valves of at least one cylinder 1-1 to 1-3 are open to push the humid air out of the engine. Alternatively or in addition, the venting valve 11 in the intake manifold 10 may be opened to allow for escaping of humid air out of the intake system.

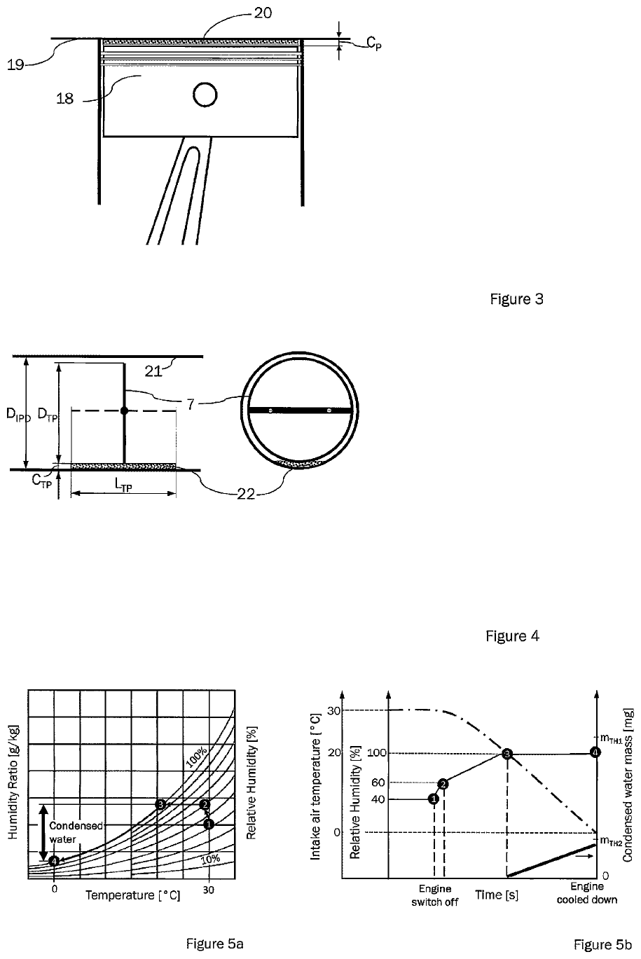

In FIG. 3 a first amount of condensed water 20 is illustrated as an example for determining the first predetermined threshold m_{TH1} of condensed liquid mass in order to prevent an engine damage in case the temperature in the intake system is above the freezing point. Liquid water entering into the cylinder during a shutdown period of the engine or at engine start can lead to a hydrostatic lock. Therefore, as an example, the amount of condensed water in the intake system should be lower than the amount of liquid 20 which would fill the distance C_{P} between the piston 18 and the fire deck 19.

FIG. 4 depicts schematically a lateral and a plan view of the throttle plate 7 mounted in an intake pipe 21 to illustrate an example for determining the second predetermined threshold m_{TH2} of condensed liquid mass in the intake system which may be still permissible in case of icing. Between the outer diameter D_{TP} of the throttle plate 7 and the inner diameter D_{IP} of the intake pipe 21 there is a crevice C_{TP} necessary to allow smooth movement of the throttle plate 7. Water which may condense in the range of the throttle plate 7 can accumulate on the lower side of the intake pipe 21. Therefore, the second amount of condensed water 22 accumulating on the lower side of the intake pipe 21 in the setting range L_{TP} of the throttle plate 7 should not exceed a high which is larger than the clearance of the crevice C_{TP}, in order to avoid blocking of the throttle plate 7 in case of icing,

FIG. 5a shows schematically an exemplary diagram for determining the formation of condensed water in the intake system by using a psychrometric chart. Point 1 marked in the diagram indicates an example for conditions in the intake system at engine switch off. According to the diagram, the intake temperature is 30° C. and the relative intake humidity is 40% at that time. At point 2 marked in the diagram the relative intake humidity is increased to 60% wherein the intake temperature has only slightly decreased. The increased relative humidity may be caused by vaporization of the wall film accumulated on the intake port walls and mixing of the vaporized water with the air in the intake system. In the following step the intake temperature drops off continually until at point 3 the saturation temperature of 20° C. is reached. At that point water condensation in the intake system starts and, in the following, persists until the engine is completely cooled down to ambient temperature. The ambient temperature in the present example is marked as 0° C. at point 4 in the diagram, so that the condensed amount of water can be determined based on the difference of the humidity ratio at 20° C. and 0° C.

FIG. 5b shows schematically the example of the four characteristic points during the cooling down period corresponding to FIG. 5a in a time-based presentation. In the presented diagram the progress of the intake temperature, the progress of the relative intake humidity and the progress of the condensed water mass are depicted. Again, point 1 represents exemplary conditions at engine switch off at which the air in the intake system has a relative humidity of 40% and a temperature of 30° C. At point 2 a certain time has passed in which the relative humidity has been increased to 60% due to the vaporization of the water wall film. Point 3 indicates the dew point at which water condensation starts and, in the following, the condensed water mass continuously increases until, at point 4, the engine is cooled down to the ambient temperature of 0° C. Since icing in the intake system can occur at that temperature, the condensed water mass should stay below the second threshold m_{TH2} as depicted, in order to prevent engine damage caused by blocking actuators such as a blocking throttle plate 7.

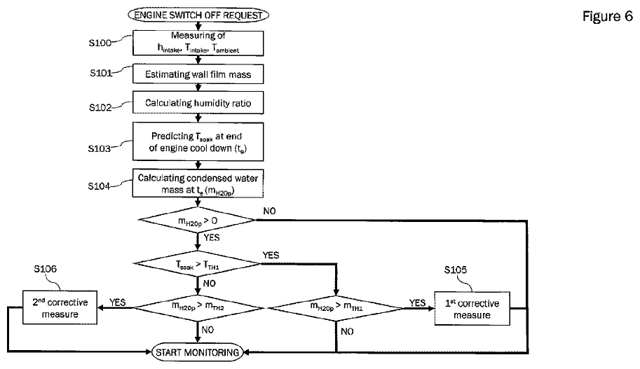

FIG. 6 depicts a flow chart which exemplary describes as to how to predict and prevent condensed water in the intake system of an internal combustion engine when the engine has cooled down. When engine switch off is requested, the intake humidity hᵢₙₜₐₖₑ, the intake temperature Tᵢₙₜₐₖₑ and the ambient temperature T_{ambient} are measured by the related sensors (S100) and the respective values are sent to the control unit 15. Then, in step S101, the control unit 15 estimates the wall film mass, for example, based on the measured conditions in the intake system and the amount of water injected into the intake ports 12-1 to 12-3 in the preceding cycle(s) before the engine switch off request, and calculates the humidity ratio after vaporization of the wall film according to the psychrometric chart as exemplary depicted in FIG. 5a (S102). Further, in step 5103, the control unit 15 predicts the soaking temperature Tₛₒₐₖ of the air inside the intake system at the end of the engine cool down period tₑ, wherein the soaking temperature may be achieved when the temperature Tᵢₙₜₐₖₑ inside the intake system is identical to the ambient temperature T_{ambient}. For this purpose, the control unit 15 may firstly calculate the time for cooling down the air in the intake system based on the currently determined conditions, for example, the intake temperature Tᵢₙₜₐₖₑ and the currently measured ambient temperature T_{ambient}. Subsequently, the predicted ambient temperature at the calculated end of the cooling down period may be estimated, for example, based on whether reports, which can be received via the internet from the next available whether station. If the forecasted ambient temperature strongly differs from the currently measured ambient temperature T_{ambient}, some iteration steps may be necessary to predict the end of the engine cool down period tₑ and the soaking temperature Tₛₒₐₖ with sufficient accuracy. Further information measured by additional engine sensors, for example the coolant temperature of the engine, may be used for improving the accuracy of the calculation. Depending on the calculated humidity ratio and the predicted soaking temperature Tₛₒₐₖ, the control unit 15 can calculate the condensed water mass at the end of the engine cool down period tₑ (S104) according to the psychrometric chart as exemplary depicted in FIG. 5a.

If condensation is predicted at a soaking temperature Tₛₒₐₖ higher than a first temperature threshold T_{TH1}, and the predicted condensed water mass m_{H2Op} in the intake system may be larger than the first predetermined threshold m_{TH1}, the first corrective measure is performed (S105), for example, one or more cranking cycles during engine switch off to fill the intake system with dry fresh air. The first temperature threshold T_{TH1} should be set around the freezing point, preferably in a temperature range of 0° C. to 5° C.

If condensation is predicted at a soaking temperature Tₛₒₐₖ lower than the first temperature threshold T_{TH1} and the predicted condensed water mass m_{H2Op} in the intake system may be larger than the second predetermined threshold m_{TH2}, the second corrective measure is performed (S106), for example, a scavenging cycle during engine switch off in order to push the humid air out of the intake system.

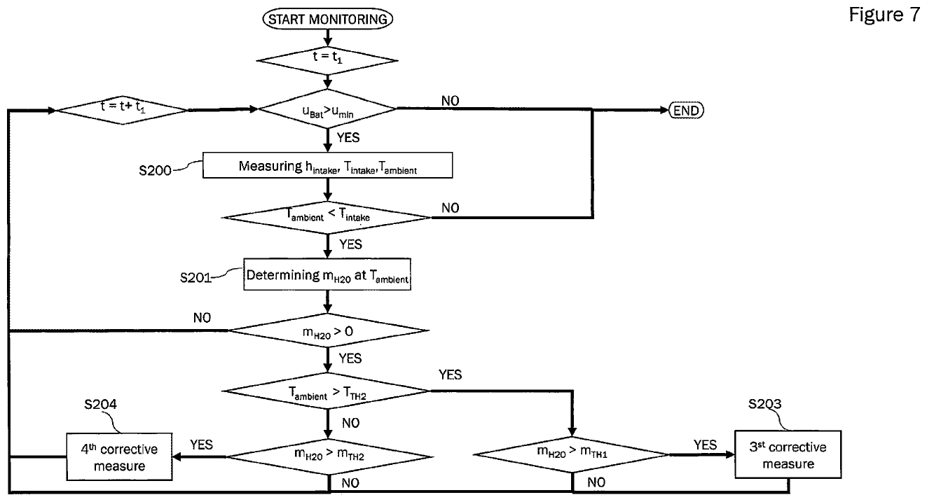

When the engine is fully stopped after finishing the explained calculations and performing the required measures, the conditions in the intake system (hᵢₙₜₐₖₑ, Tᵢₙₜₐₖₑ) may be measured again and water condensation therein may be further monitored during the engine cool down period as described in FIG. 7.

FIG. 7 depicts a flow chart which describes by way of example as to how to determine and prevent condensed water during the cooling down period of the engine. At a predetermined time t₁ after engine switch off the control unit 15 checks if the battery voltage is above a minimum level. The predetermined time t₁ may be in a range of 1 s to 20 min and the minimum battery voltage level may be in a range of 7V to 9V. If the battery voltage is above the minimum level, intake humidity hᵢₙₜₐₖₑ, intake temperature Tᵢₙₜₐₖₑ and ambient temperature T_{ambient} are measured (S200). As long as the intake temperature Tᵢₙₜₐₖₑ is higher than the ambient temperature T_{ambient}, the control unit 15 determines whether and in which amount condensed water can occur in the intake system at the measured ambient temperature T_{ambient} (S201).

If condensed water is determined at an ambient temperature T_{ambient} higher than a second temperature threshold T_{TH2}, and the determined water mass m_{H2O} in the intake system is larger than the first predetermined threshold m_{TH1}, the third corrective measure is performed (S203), for example, controlling the e-booster 4 to deliver a first predetermined air mass flow for a first predetermined ventilation time during which the intake valve 16 and the exhaust valve 17 are switched in valve overlap position and/or the venting valve 11 is opened. The second temperature threshold T_{TH2} should preferably be set in a temperature range of 10° C. to 15° C. in order to reliably avoid freezing of condensed water during the cool down period of the engine.

If condensed water is determined at an ambient temperature T_{ambient} lower than the temperature threshold T_{TH2}, and the determined water mass m_{H2O} in the intake system is larger than the second predetermined threshold m_{TH2}, the fourth corrective measure is performed (S204), for example, controlling the e-booster 4 to deliver a second predetermined air mass flow for a second predetermined ventilation time during which the intake valve 16 and the exhaust valve 17 are switched in valve overlap position and/or the venting valve 11 is opened.

The above described calculations and corrective measures can be performed repeatedly in predetermined time steps t₁ as long as the battery voltage u_{bat} stays above the minimum level uₘᵢₙ. The procedure may be finished when the intake temperature Tᵢₙₜₐₖₑ has reached the ambient temperature T_{ambient}.

Instead of determining water condensation during the cool down period or in addition thereto, the previously predicted mass of condensed water m_{H2Op} at the end of the cool down period tₑ may be adapted by currently measured boundary conditions (hᵢₙₜₐₖₑ, Tᵢₙₜₐₖₑ, T_{ambient}). Especially if no condensation is predicted and no corrective measure has been carried out during the engine shut down, it may be advantageous to double check the prediction during the cool down period. In this case, the third or fourth corrective measure may be performed even before water condensation occurs and therefore engine damage may be prevented effectively.

Features of the different embodiments, aspects and examples, which are described herein and which are shown by the Figures, may be combined either in part or in whole. The herein described invention shall also entail these combinations.

Again summarizing, the present subject-matter offers a method and a control unit 15 to determine and prevent condensed liquid in the intake system of a stopped engine. The control unit 15 determines if and in which amount condensed liquid occurs in the cooled intake system and initiates appropriate actions to eliminate the liquid therefrom. Hence, engine damages caused by water condensation can be prevented with high reliability.

### REFERENCE SIGNS LIST

1, 1-1, 1-2, 1-3: cylinder, 2: turbo charger, 2a: compressor, 2b: turbine, 3: first bypass plate, 4: electrical booster, e-booster, 5: charge air cooler, 6: second bypass plate, 7: throttle plate, 8: intake humidity sensor, 9: intake temperature sensor, 10: intake manifold, 11: venting valve, 12, 12-1, 12-2, 12-3: intake port, 13-1, 13-2, 13-3: water injector, 14, 14-1, 14-2, 14-3: exhaust port, 15: control unit, 16: intake valve, 17: exhaust valve, 18: piston, 19: fire deck, 20: first amount of condensed water, 21: intake pipe, and 22: second amount of condensed water.

1. Method for avoiding condensation of humidity in an intake system of an internal combustion engine,
the method determining a liquid mass (m_{H2O}, m_{H2O}) condensing in the intake system at least one predetermined timing after engine switch off request, based on a determined humidity (hᵢₙₜₐₖₑ) in the intake system, a determined temperature (Tᵢₙₜₐₖₑ) in the intake system and a determined ambient temperature (T_{ambient}); and
initiating a corrective measure if the determined condensed liquid mass (m_{H2Op}, m_{H2O}) exceeds a predetermined threshold (m_{TH1}, m_{TH2}).

2. Method according to claim 1, wherein the prediction of the condensed liquid mass (m_{H2Op}) comprises the steps of:
measuring the relative humidity (hᵢₙₜₐₖₑ) and the temperature (Tᵢₙₜₐₖₑ) in the intake system and calculating a first humidity ratio in the intake system based on the measured values,
estimating a liquid mass stored as film on walls of the intake system,
calculating a second humidity ratio in the intake system including the liquid wall film mass and the first humidity ratio,
measuring the ambient temperature (T_{ambient}) and estimating a cooling down period until the intake air cools down to ambient temperature (T_{ambient}), and
calculating the condensed liquid mass depending on the second humidity ratio and an estimated soaking temperature (Tₛₒₐₖ) at end of the cooling down period (tₑ).

3. Method according to claim 2, wherein,
if the predicted condensed liquid mass exceeds a first predetermined threshold (m_{TH1}) and the estimated soaking temperature (Tₛₒₐₖ) at the end of the cooling down period (tₑ) is higher than a first predetermined temperature (T_{TH1}), a first corrective measure as the corrective measure is initiated after engine switch off request.

4. Method according to claim 3, wherein,
to perform the first corrective measure,
a control unit initiates a predetermined number of cranking cycles after engine switch off request.

5. Method according to claim 3, wherein,
if the predicted condensed liquid mass (m_{H2Op}) exceeds a second predetermined threshold (m_{TH2}) smaller than the first predetermined threshold (m_{TH1}), and the estimated soaking temperature (Tₛₒₐₖ) at the end of the cooling down period (tₑ) is lower than the first predetermined temperature (T_{TH1}), a second corrective measure as the corrective measure is initiated after engine switch off request.

6. Method according to claim 5, wherein,
to perform the second corrective measure,
the control unit initiates a predetermined number of scavenging cycles after engine switch off request by switching an intake valve and an exhaust valve in a valve overlap position and controlling an e-booster to provide a predetermined boost pressure.

7. Method according to claim 1, wherein
the humidity (hᵢₙₜₐₖₑ) in the intake system, the temperature (Tᵢₙₜₐₖₑ) in the intake system and the ambient temperature (T_{ambient}) are frequently measured at predetermined timings during the cooling down period after engine switch off until the temperature in the intake system is equal to the ambient temperature (T_{ambient}) and the condensed liquid mass (m_{H2O}) is determined based on the measured values at each timing.

8. Method according to claim 3, wherein,
if the determined condensed liquid mass (m_{H2O}) exceeds the first predetermined threshold (m_{TH1}), and the measured ambient temperature (T_{ambient}) is higher than a second predetermined temperature (T_{TH2}), a third corrective measure as the corrective measure is initiated.

9. Method according to claim 8, wherein,
to perform the third corrective measure,
the control unit switches the intake valve and the exhaust valve in the valve overlap position and/or opens a venting valve and controls the e-booster to deliver a first predetermined air mass flow for a first predetermined ventilation time.

10. Method according to claim 8, wherein,
if the determined condensed liquid mass (m_{H2O}) exceeds a second predetermined threshold (m_{TH2}), and the measured ambient temperature is lower than the second predetermined temperature (T_{TH2}), a fourth corrective measure as the corrective measure is initiated.

11. Method according to claim 10, wherein,
to perform the fourth corrective measure,
the control unit switches the intake valve and the exhaust valve in a valve overlap position and/or opens the venting valve and controls the e-booster to deliver a second predetermined air mass flow for a second predetermined ventilation time.

12. Control unit for an internal combustion engine having at least one cylinder, at least one intake valve, at least one exhaust valve, at least one e-booster, at least one venting valve, at least one humidity sensor, at least one temperature sensor and at least one non-combustible fluid injector for injecting non-combustible fluid in at least one intake port of the internal combustion engine,
the control unit configured to perform the method according to claim 1.

13. Internal combustion engine including the control unit of claim 12.

14. A computer program product storable in a memory comprising instructions which, when carried out by a computer, cause the computer to perform the method according to claim 1.
